(19) United States
(12) Patent Application Publication
(10) Pub. No.: US 2025/0326931 A1
(43) Pub. Date: Oct. 23, 2025

(54) WRITING UTENSIL COMPRISING A PLA/PBS SHAFT BASE MATERIAL

(71) Applicant: STAEDTLER SE, Nürnberg (DE)

(72) Inventor: Andreas THIES, Adelsdorf (DE)

(21) Appl. No.: 18/862,097

(22) PCT Filed: May 15, 2023
(86) PCT No.: PCT/EP2023/025227

§ 371 Date: Oct. 31, 2024

(30) Foreign Application Priority Data
Jun. 3, 2022 (DE) 10 2022 114 169.1

(51) Int. Cl. C08L 97/02; B43K 19/14; C08L 1/02

(52) U.S. Cl. CPC C08L 97/02; B43K 19/14; C08L 1/02; C08L 2205/035

(57) ABSTRACT

A writing utensil including a lead and a shaft, wherein the lead is arranged in the shaft in a stationary manner, and the shaft has a shaft base material. The shaft base material includes the following components: 60 to 75 wt. % of a filler/fillers, 15 to 30 wt. % of a binder mixture including PLA and a second binder selected from the group of PBS and copolymers of the PBS, in particular PBSA, 0.2 to 6 wt. % of other additives such as adhesives, stabilizers, 1 to 10 wt. % of wax/waxes, and 0 to 4 wt. % of a dye, in particular a pigment.

The invention relates to a pencil with the features of the preamble of claim 1.

Pencils with a shaft made of wood have long been known. The prices for wood have increased in the past and this increases manufacturing costs. Production processes have therefore been developed which coat the lead with polymers by extrusion. Polystyrene (PS), for example, is used as a base polymer of the shaft material. Polystyrene has the advantage of good availability, easy processability and good mechanical properties of the resulting shaft. Polystyrene has the disadvantage that it is not biodegradable.

Against this background, document DE 10 2008 034 013 B4 proposes the use of a wood substitute for the shaft of a pencil, wherein the wood substitute is based on a polymeric binder.

Such an extruded pencil is also known for example from EP 0 505 262 B1, which forms the closest prior art. The pencil described therein is made of foamed polystyrene in the sheath and a flexible polystyrene-bonded lead.

It is the problem of the present invention to propose a pencil which represents a sustainable alternative to the prior art, wherein at the same time the properties of use of the pencil, in particular the sharpening ability and the bending strength, are to be maintained. This problem is solved by a pencil with the features of claim 1. Preferred or advantageous embodiments of the invention emerge from the sub-claims, the following description and the appended figure.

The subject-matter of the present invention is a pencil, wherein the pencil comprises a lead and a shaft, wherein the shaft surrounds the lead preferably concentrically and/or coaxially and wherein the lead is arranged with the shaft so as to be fixed and/or non-displaceable relative to one another. In particular, the lead is permanently fixed non-displaceable in the shaft and/or not detachable free from destruction. For example, the shaft is optionally connected to the shaft by intermediate layers in a firmly bonded, force-fitting and/or form-fitting manner. The shaft is arranged around the lead. It serves to support and protect the lead and has a larger diameter than the lead. This allows the fingers to hold the shaft and to guide the pencil well. The shaft comprises a material which is referred to as the shaft base material. Further layers, for example decorative layers, can be arranged on the shaft base material.

The pencil is designed in particular as a straight cylinder, wherein the cylinder base surface or the cross-sectional area can for example be constituted round, oval, triangular, rectangular, pentagonal, hexagonal or polygonal. Alternatively, the pencil can be twisted or can be designed twisted.

The lead is designed in particular so that it can be sharpened. For example, it can be sharpened with a pencil sharpener, for example a coloured pencil sharpener, a lead pencil sharpener, sharpening machines or cosmetic pencil sharpeners, wherein a conical tip of the pencil can be created or reworked by a severing material removal from the shaft and from the lead. A pencil is referred to as being able to be sharpened when a person is able to perform manually a severing material removal on the pencil with a blade in a housing with moderate expenditure of force, so that the conical tip is produced.

The shaft comprises a shaft base material, wherein the shaft is preferably made at least 60 wt.-%, preferably at least 80 wt.-% and in particular at least 98 wt.-% or even 100 wt.-% of the shaft base material. Alternatively or in addition, the cross-sectional area of the shaft preferably comprises at least 80% of the cross-sectional area, preferably at least 90% of the cross-sectional area and in particular at least 98% of the cross-sectional area or even 100% of the cross-sectional area.

In particular, the shaft comprises a shaft body made of the shaft base material. The shaft body is formed in a ring-shaped manner in cross-section, for example in the form of a circular ring. In particular, the inner contour can be formed circular and/or the outer contour can be arbitrary, e.g. round, oval, triangular, rectangular, pentagonal, hexagonal or polygonal.

In the context of the invention, it is proposed that the shaft base material comprises the following components related to the shaft base material, in particular to the total weight of the shaft base material:

The shaft base material comprises the following components:

| | |
|---|---|
| 60 to 75 wt.-% | filler (s) |
| 15 to 30 wt.-% | binder mixture comprising PLA and a second binder |
| | selected from the group consisting of PBS, |
| | copolymers of PBS, in particular PBSA, |
| 0.2 to 6 wt.-% | other additives such as adhesion promoters, stabilisers |
| 1 to 10 wt.-% | wax(es) |
| 0 to 4 wt.-% | colourants, in particular as a pigment. |

In particular, the shaft base material has a proportion of filler of more than 60 wt.-%, which corresponds to a high proportion. The shaft base material can also comprise a mixture of plurality of fillers. The shaft base material comprises 60 to 75 wt.-% of the sole filler or the mixture of fillers. It is possible to select the latter from biodegradable material.

Furthermore, costs can be reduced by the proportion of the filler, since the filler reduces the use of binder.

In particular, the shaft base material neither comprises an addition of chemical additives that release a gas by thermal decomposition, nor is the melt physically foamed by introducing gas in the extrusion. The shaft base material is preferably unfoamed. A very small bubble formation in the shaft base material by volatile constituents of the respective starting raw materials is not however ruled out at the process temperatures used.

In particular, the filler fraction also has the advantage that the shaft is not flexible and therefore rigid, brittle high-quality leads are supported in a fracture-proof manner by the shaft base material.

Furthermore, the shaft base material comprises a binder mixture of PLA and at least a second binder. PLA also includes in particular PLA blends or PLA components. PLA is a designation for polylactic acid, which in particular can be referred to as polylactide and/or polylactic acid. In particular, PLA is also registered in the Chemical Abstracts Service under the number CAS: 9051-89-2. Depending on the number of monomers in the polymer, the properties of PLA as a polymer can vary somewhat.

PLA is a thermoplastic. PLA has the advantage that it can be produced bio-based, so that the use of petroleum-based raw materials in the pencil is significantly reduced or completely prevented. PLA is obtained, for example, from maize and as a synthetic polymer belongs to the polyesters. Thus, pure PLA is preferably produced from renewable raw materials and is not based on fossil raw materials, such as for example petroleum.

In addition, PLA is compostable and, in particular in an industrial composting plant, can be decomposed into harmless end products within a manageable period of for example less than 12 weeks, in particular according to standard EN 14995 or EN 13432, other similar standards being able to be define other conditions and time periods. Industrial composting conditions, i.e. controlled temperature and humidity conditions, in the presence of microorganisms, are necessary for the composting or decomposition of PLA. For example, the temperatures must be 55 to 70° C. By means of industrial composting, it is possible to decompose the shaft of the pencil according to the standard into harmless end products and to denote the latter as biodegradable.

The PLA-based binder mixture comprises at least a second binder as a second component, which is selected from the group consisting of PBS, copolymers of PBS, in particular PBSA. In this case, PBS is a designation which stands for polybutylene succinate (e.g. CAS: 25777-14-4). PBSA is a designation which stands for poly (butylene succinate-co-butylene adipate) (e.g. CAS: 6742306-7). Depending on the number of monomers in the polymer, the properties of the polymer may vary somewhat. PBS and PBSA are more biodegradable than PLA. Both also have thermoplastic properties. The starting materials for polymerisation can be produced from glucose or fructose. In this way, PBS and PBSA can be produced bio-based.

Furthermore, the shaft base material comprises other additives. The group of other additives comprises adhesion promoters, stabilisers and others. Adhesion promoters are preferably used for better adhesion of the fillers to the binder mixture. They can also be used for better adhesion of the lead in the shaft base material. An example of an adhesion promoter would be a maleic acid anhydride-grafted polymer selected from the group of polyesters comprising PLA, PBS, PBSA, etc.

Stabilisers are added to reduce the ageing processes of the polymer. Thus, heat, light, ozone and oxygen effects can lead to ageing processes, which can be seen in the deterioration of the properties, for example as colour changes.

Furthermore, the shaft base material comprises at least one wax. The shaft base material can also comprise a mixture of a plurality of waxes. The shaft base material thus comprises 1 to 10 wt.-% of the sole wax or the mixture of waxes. In particular, the wax serves to adjust the extrusion properties, for example to improve the flow behaviour, and/or to adjust the sharpening ability. In particular, a lighter removal of material from the shaft and from the lead is achieved, so that a conical tip of the pencil can be created. The wax can serve as an aid to extrusion (improvement of the flow properties, reduction of the melt-wall adhesion to machine parts and/or tool parts), but it can also have a favourable effect on the material structure with regard to the mechanical machining thereof. This is particularly important in the manual sharpening operation of the pencil by the user with the aid of a pencil sharpener.

In particular, the at least one wax has a melting point which is such that it is present in the extruder as a liquid and can influence the flow behaviour of the melt and/or of the heated shaft base material.

Furthermore, the shaft base material preferably comprises colourants. These are used in particular for brightening the hue of the shaft base material. It was found to be advantageous if a white pigment, e.g. titanium dioxide (TiO₂), is used for brightening the hue.

The proposed composition of the shaft base material permits the production of a shaft which has the properties of sharpening ability, grip, mechanical, thermal and chemical stability forms a necessary for pencils. Thus, the binder mixture sustainable alternative to the base polymers used hitherto for the production of the pencil shaft.

It has been found particularly advantageous in the selection of the binder mixture that, in particular in comparison with other plastics, the properties, such original as for example sharpening ability, breaking strength, haptics, are not changed negatively compared to the polymers from the prior art. The binder mixture thus represents a valuable, sustainable substitution for the previously known polymers.

In a preferred embodiment of the filler, it is selected from a group comprising wood flour, wood fibres and/or cellulose. A form of wood flour is referred to as lignocellulose. Lignocellulose comprises the lignin of the wood in the cellulose. Lignocellulose can be produced from wood by mechanical comminution, in particular as wood pulp, pressurised groundwood, wood chips, etc. These fillers are bio-based and/or biodegradable and are available at low cost. In particular, the filler can contain further substances in addition to the wood flour, wood fibres and/or cellulose.

In a further embodiment, the shaft base material comprises a mixture of fillers. In particular, a mixture of organic fillers with additional organic and/or inorganic substances, for example talc, chalk, kaolin, etc.

In an embodiment, the filler or the fillers are at least largely or completely organic. Thus, the filler(s) can consist entirely of wood flour, wood fibres, cellulose and mixtures thereof, in order to be referred to as completely organic.

In a further embodiment, in addition to the organic fillers such as wood flour, wood fibres and/or cellulose, further organic fillers may be present as a mixture with the organic fillers. The organic fillers are present in the mixture of fillers in the range from greater than 0 to 10 wt.-related to the weight of the filler. The organic filler is for the most part present in the mixture of fillers with greater than or equal to 90 wt.-% related to the weight of the filler. The filler or the fillers are thus largely organic.

In a further embodiment, the shaft base material has a content of filler or fillers in the range from 60 to 75 wt.-%, preferably in the range from 68 to 73 wt.-% in relation to the shaft base material. This enables a high proportion of filler.

In a first possible alternative, the binder mixture comprises PLA, the second binder and further binders. In a second possible alternative, the binder mixture consists or essentially consists of PLA and the second binder.

In a further embodiment, the binder mixture is in the range from 17 to 27 wt.-%, preferably in the range from 19 to 23 wt.-% with respect to the shaft base material. The proportion of binder is in particular selected in such a way that an adaptation of the bending strength and of the modulus of elasticity is achieved in order to support a stiff, brittle, but high-quality lead in a fracture-proof manner in the shaft base material. This has the advantage that the shaft base material is optimised for mechanical properties.

In a preferred development, the binder mixture comprises only the second binder in addition to the PLA. Alternatively or in addition, the binder mixture consists of the PLA and the second binder or the binder mixture essentially consists of the PLA and the second binder. The PLA is present in the weight ratio to the second binder in the range from 10:1 to 1:10.

This has the advantage that the properties of the compound with the PLA can be modified by the second binder in the binder mixture. The biodegradability can thus be increased by adding PBS or PBSA. The mechanical and/or elastic properties can be optimised. The raw material costs can be optimised.

In a preferred development, the other additives comprise an adhesion promoter, wherein the latter improves the adhesion between the filler and the binder mixture.

In a preferred development, the adhesion promoter comprises an MAH grafted polymer, in particular selected from the group of polyesters comprising PLA, PBS, PBSA, etc. and mixtures thereof. MAH is here a designation for maleic acid anhydride, which in particular also stands for maleic anhydride (CAS: 108-31-6). MAH grafted PLA can in particular be referred to as maleic acid anhydride grafted polylactide and/or maleic anhydride grafted polylactic acid.

MAH grafted PBS can be referred to in particular as maleic acid anhydride grafted polybutylene succinate. MAH grafted PBSA can in particular be referred to as maleic acid anhydride grafted poly (butylene succinate-co-butylene adipate). In another embodiment, the adhesion promoter comprises a mixture of MAH grafted PLA, MAH grafted PBS and MAH grafted PBSA. The mixture of MAH grafted PLA, MAH grafted PBS and MAH grafted PBSA can be present in different ratios. As a result of the MAH fraction in the adhesion promoter, the latter can on the one hand react with the filler via an esterification of the OH groups, on the other hand it can be integrated compatibly in the primary matrix of the polymers by the similar base polymers.

In a preferred development, the shaft base material has a content of the adhesion promoter in the range from 0.2 to 6 wt.-%, preferably in the range from 1 to 3 wt.-related to the shaft base material, in particular related to the total weight of the shaft base material. The precise content of the adhesion promoter is determined by various factors, i.e. by the degree of grafting with MAH and the stearic availability of the functional groups.

In a further embodiment, the at least one wax is suitable for adjusting the extrusion properties and/or sharpening ability of the shaft base material.

In a preferred embodiment, the at least one wax is selected from a group comprising stearic acid waxes and stearic acid derivatives; palmitic acid waxes and palmitic acid derivatives, silicone waxes, EBS, polyolefin waxes such as oxidised, non-oxidised polyethylene wax and/or oxidised, non-oxidised polypropylene wax and mixtures thereof. Distearyl ethylene diamide is known in particular a designation for ethylene bis(stearamide) and/or as EBS (CAS: 110-30-5).

If the properties of a single wax cannot provide a satisfactory operating point with respect to the extrusion properties and the sharpening ability of the shaft base material, a mixture of a plurality of different waxes is preferably used.

In addition to a first high-melting wax of this kind, which improves the extrusion properties, at least one additional comparatively low-melting wax of this kind, which improves the sharpening ability, is preferably mixed in.

The first wax has a melting point of for example above 100° C. This improves the flow behaviour of the melt, so that the heated shaft base material flows better out of the extruder. The first wax is selected in particular from a group comprising EBS, polyolefin waxes such as oxidised, non-oxidised polyethylene wax and/or oxidised, non-oxidised polypropylene wax and mixtures thereof.

The additional wax has a melting point of for example below 100° C. This has the advantage that the sharpening of the pencil is made easier. The additional wax is selected in particular from a group comprising stearic acid waxes and stearic acid derivatives, palmitic acid waxes and palmitic acid derivatives, silicone waxes and mixtures thereof.

The proportion of wax(es) preferably lies in the range of 1 to 10 wt.-%, preferably in the range of 2 to 6 wt.-% related to the total weight of the shaft base material. The waxes can be present as a mixture of at least two waxes. In particular, in the case of a mixture of the first wax and the additional wax, each of these waxes is present in the range from 1 to 5 wt.-%, preferably in the range of 2 to 4 wt.-% related to the total weight of the shaft base material.

In a further embodiment, the colourant preferably lies in the range from 0 to 3 wt.-%, preferably in the range from 0 to 2 wt.-%. The colourant has the function of brightening the relatively dark basic colour of the polymer filler mixture and of imparting a uniform and natural hue. The natural fluctuation of the fillers can also be compensated for by changing contents.

In a preferred development of the invention, the lead is produced on the basis of PLA. In particular, the lead comprises PLA as a binder. The lead is preferably from the constituents such as they are described in publication DE 10 2013 016 355 A1, the disclosure content of which is incorporated in the description via referencing (“incorporated by reference”).

In particular, the lead comprises a lead base material, wherein the lead base material comprises the following components:

| | |
|---|---|
| 10 to 40 wt.-% | PLA |
| 30 to 80 wt.-% | lead filler |
| 0 to 20 wt.-% | waxes/lubricants |
| 0 to 10 wt.-% | additives such as for example |
| | plasticisers, stabilisers, adhesion promoters |

The polylactide proportion of the lead base material lies in the range from 10 to 60 wt.-%, preferably in a range from 10 to 40 wt.-% and particularly preferably in the range from 10 to 25 wt.-%.

It has been shown to be advantageous if the lead base material comprises

| | |
|---|---|
| 10 to 60 wt.-% | polylactide |
| 2 to 25 wt.-% | wax |
| 15 to 70 wt.-% | fillers, in particular lead fillers |
| 0 to 5 wt.-% | palm oil |
| 0 to 30 wt.-% | colourant |

In a preferred development of the invention, the shaft base material and the lead base material are directly connected to one another. In particular, they are connected to one another in a firmly bonded manner. By selecting PLA for the two base materials, an intermediate layer can advantageously be dispensed with, since these similar polymers can adhere to one another without further measures. Thus, the adhesion promoter layer can be saved by the choice of similar base materials and a stable composite can also be built up.

In particular, the organic components of the lead are also degradable under the boundary conditions of the industrial biological composting of PLA or are bio-based, as has already been described above.

In a further embodiment, the pencil is designed in such a way that it can be used as a writing and/or painting pencil and/or as a cosmetic pencil.

Further features, advantages and effects of the invention result from the following description of a preferred example of embodiment of the invention and from the appended figures. These show:

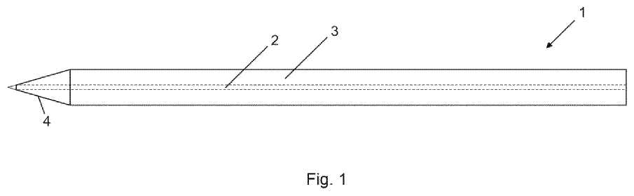

FIG. 1 a diagrammatic representation of a pencil which is able to be sharpened.

FIG. 1 shows in a highly diagrammatic block diagram a pencil 1 with a lead 2, a shaft 3 made of a shaft base material. Pencil 1 can be sharpened and comprises a conical region 4 in shaft 3 and lead 2, which is produced by a pencil sharpener. As a result, lead 2 is exposed. Lead 2 is arranged in shaft 3 in a fixed manner against displacement. This prevents lead 2 from slipping. Lead 2 is thus not displaced in shaft 3 when a certain degree of pressure is exerted on pencil 1 during writing. Shaft 3 comprises a material called the shaft base material. Further layers can be arranged on the shaft base material, for example decorative layers.

The shaft base material comprises the following components:

| | |
|---|---|
| 60 to 75 wt.-% | filler (s) |
| 15 to 30 wt.-% | binder mixture comprising PLA and a |
| | second binder selected from the group |
| | consisting of PBS, copolymers of PBS, |
| | in particular PBSA |
| 0.2 to 6 wt.-% | other additives such as adhesion |
| | promoters, stabilisers |
| 1 to 10 wt.-% | wax (es) |
| 0 to 4 wt.-% | colourants, in particular as a pigment |

Exemplary shaft base materials are shown below.

The production of a shaft according to the invention preferably takes place after mixing and granulating the components of the shaft base material in the extrusion process or coextrusion process as sheathing of the provided lead at approximately 150 to 200° C.

The shape of the cross-sectional area is set in the extrusion head. After cooling, the pencil thread is cut to a certain length.

Preferably, the wood flour, wood fibres and/or cellulose are present as particles. The particles preferably have an average particle size which can be specified as d50 in μm. The designation d50=150 μm means that 50% of the particles are smaller than 150 μm and 50% are larger. The particle size distribution can be determined for example using a laser granulometer.

Example 1 Painting pencil with a shaft base material comprises the following components:

| | |
|---|---|
| 73 wt.-% | wood flour (d50 approx. 100 μm) as filler |
| 10 wt.-% | PLA (polylactide, polylactic acid, polylactic |
| | acid) in the binder mixture |
| 10 wt.-% | PBS (polybutylene succinate) in the binder mixture |
| 1 wt.-% | MAH grafted PLA (maleic acid anhydride grafted |
| | polylactide, maleic anhydride grafted polylactic |
| | acid) as other additives especially adhesion |
| | promoters |
| 3 wt.-% | stearic acid derivative wax in the wax agent |
| 2 wt.-% | EBS (distearyl ethylene diamide) in the wax agent |
| 1 wt.-% | titanium dioxide as a colourant, in particular as |
| | a pigment |

The advantage is the high filler proportion, as a result of which a largely biodegradable shaft of a pencil can be produced.

Example 2 Writing pencil with a shaft base material comprises the following components:

| | | |
|---|---|---|
| 61.5 | wt.-% | wood flour (d50 approx. 35 μm) as filler |
| 10 | wt.-% | PLA (polylactide, polylactic acid, polylactic |
| | | acid) in the binder mixture |
| 20 | wt.-% | PBS (polybutylene succinate) in the binder mixture |
| 1.5 | wt.-% | MAH grafted PLA (maleic acid anhydride grafted |
| | | polybutylene succinate) as other additives |
| | | especially adhesion promoters |
| 1.5 | wt.-% | stearic acid derivative wax in the wax agent |
| 3.5 | wt.-% | EBS (distearyl ethylene diamide) in the wax agent |
| 2 | wt.-% | titanium dioxide as a colourant, in particular as |

a pigment.

The advantage is the high filler proportion in conjunction with biodegradable binders, as a result of which a largely biodegradable shaft of a pencil can be produced.

Example 3 Writing pencil with a shaft base material comprises the following components:

| | | |
|---|---|---|
| 60.5 | wt.-% | wood flour (d50 approx. 70 μm) as filler |
| 25 | wt.-% | PLA (polylactide, polylactic acid, polylactic |
| | | acid) in the binder mixture |
| 5 | wt.-% | PBS (polybutylene succinate) in the binder mixture |
| 6 | wt.-% | MAH grafted PLA (maleic acid anhydride grafted |
| | | polylactide, maleic anhydride grafted polylactic |
| | | acid) as other additives especially adhesion |
| | | promoters |
| 1 | wt.-% | stearic acid derivative wax in the wax agent |
| 1.5 | wt.-% | EBS (distearyl ethylene diamide) in the wax agent |
| 1 | wt.-% | titanium dioxide as a colourant, in particular as |

a pigment.

The advantage is the high filler proportion in conjunction with biodegradable binders, as a result of which a largely biodegradable shaft of a pencil can be produced. The adhesion promoter enables better stability.

Example 4 Writing pencil with a shaft base material comprises the following components:

71.5 wt .- %
cellulose as a filler

| | | |
|---|---|---|
| 2 | wt.-% | PLA (polylactide, polylactic acid, polylactic |
| | | acid) in the binder mixture |
| 20 | wt.-% | PBSA (poly (butylene succinate-co-butylene |
| | | adipate) ) in the binder mixture |
| 2 | wt.-% | MAH grafted PBSA (maleic acid anhydride grafted |
| | | poly (butylene succinate-co-butylene adipate) ) as |
| | | other additives especially adhesion promoters |
| 2 | wt.-% | stearic acid derivative wax in the wax agent |
| 2 | wt.-% | EBS (distearyl ethylene diamide) in the wax agent |
| 0.5 | wt.-% | titanium dioxide as a colourant, in particular as |

a pigment.

Example 5 Black cosmetic pencil with a shaft base material comprises the following components:

| | | |
|---|---|---|
| 69 | wt.-% | wood flour (d50 approx. 100 μm) as filler |
| 10 | wt.-% | PLA (polylactide, polylactic acid, polylactic |
| | | acid) in the binder mixture |
| 15 | wt.-% | PBS (poly (butylene succinate) in the binder |
| | | mixture |
| 1.5 | wt.-% | mixture 1.1 MAH grafted PLA (maleic acid anhydride |
| | | grafted polylactide, maleic anhydride grafted |
| | | polylactic acid) : MAH grafted PBS (maleic acid |
| | | anhydride grafted polybutylene succinate) as other |
| | | additives especially adhesion promoters |
| 1 | wt.-% | stearic acid derivative wax in the wax agent |
| 2.5 | wt.-% | EBS (distearyl ethylene diamide) in the wax agent |
| 1 | wt.-% | soot as a colourant, in particular as a pigment. |

Example 6 Writing pencil with a shaft base material comprises the following components:

| | |
|---|---|
| 66 wt.-% | cellulose as a filler |
| 8 wt.-% | PLA (polylactide, polylactic acid, polylactic |
| | acid) in the binder mixture |
| 15 wt.-% | PBSA (poly (butylene succinate-co-butylene |
| | adipate) ) in the binder mixture |
| 5 wt.-% | MAH grafted PBSA (maleic acid anhydride grafted |
| | poly (butylene succinate-co-butylene adipate) ) as |
| | other additives especially adhesion promoters |
| 3 wt.-% | stearic acid derivative wax in the wax agent |
| 2 wt.-% | EBS (distearyl ethylene diamide) in the wax agent |
| 1 wt.-% | titanium dioxide as a colourant, in particular as |
| | a pigment. |

With these examples, shaft base materials can be produced having a high proportion of filler which is biodegradable. In addition, bio-based compostable binders are used.

The pencil with one of the preceding examples as a shaft base material is provided in the product lines writing pencil, painting pencil and cosmetic pencil.

### LIST OF REFERENCE NUMBERS

1 pencil
2 lead
3 shaft
4 conical region

1-15. (canceled)

16. A pencil, comprising: a lead; and a shaft, wherein the lead is arranged in the shaft in a fixed manner against displacement, wherein the shaft comprises a shaft base material that comprises the following components:

| | |
|---|---|
| 60 to 75 wt.-% | filler (s); |
| 15 to 30 wt.-% | binder mixture comprising PLA and a second binder |
| | selected from the group consisting of PBS, copolymers |
| | of PBS; |
| 0.2 to 6 wt.-% | other additives; |
| 1 to 10 wt.-% | wax; and |
| 0 to 4 wt.-% | colorants. |

17. The pencil according to claim 16, wherein the second binder is PBSA.

18. The pencil according to claim 16, wherein the other additives are adhesion promoters or stabilizers.

19. The pencil according to claim 16, wherein the colourant is a pigment.

20. The pencil according to claim 16, wherein the shaft base material is unfoamed.

21. The pencil according to claim 16, wherein the filler is largely or completely organic.

22. The pencil according to claim 16, wherein the filler is at least one of the group consisting of wood flour, wood fibers and cellulose.

23. The pencil according to claim 16, wherein the shaft base material comprises 65 to 74 wt.-% of filler(s).

24. The pencil according to claim 23, wherein the shaft base material comprises 67 to 73 wt.-% of filler(s).

25. The pencil according to claim 16, wherein the binder mixture is from 15 to 25 wt.-% of the shaft base material.

26. The pencil according to claim 16, wherein the PLA is present in the binder mixture in a weight ratio to the second binder in a range from 10:1 to 1:10.

27. The pencil according to claim 16, wherein the other additives comprise at least one adhesion promoter that is constituted as MAH grafted polymer.

28. The pencil according to claim 27, wherein the at least one adhesion promoter is constituted as polyester.

29. The pencil according to claim 27, wherein the at least one adhesion promoter is selected from the group consisting of: MAH grafted PLA, MAH grafted PBS, MAH grafted PBSA, and mixtures thereof.

30. The pencil according to claim 27, wherein the shaft base material has a content of the at least one adhesion promoter in a range of 0.2 to 6 wt.-% related to the shaft base material.

31. The pencil according to claim 30, wherein the shaft base material has a content of the at least one adhesion promoter in a range of 1 to 3 wt.-% related to the shaft base material.

32. The pencil according to claim 16, wherein the shaft base material comprises 2 to 6 wt.-% of wax.

33. The pencil according to claim 16, wherein the wax comprises a mixture of a first high-melting wax and a second wax that is low-melting compared to the first wax.

34. The pencil according to claim 33, wherein in the mixture of the first wax and the second wax, the respective waxes are present in a range of 1 to 5 wt.-% related to the shaft base material.

35. The pencil according to claim 34, wherein in the mixture of the first wax and the second wax, the respective waxes are present in a range of 2 to 4 wt.-% related to the shaft base material.

36. The pencil according to claim 16, wherein the shaft base material comprises the colorant in a range of 0 to 3 wt.-% related to the shaft base material.

37. The pencil according to claim 36, wherein the shaft base material comprises the colorant in a range of 1 to 2 wt.-% related to the shaft base material.

38. The pencil according to claim 16, wherein the pencil is one of: a writing pencil, a painting pencil; and a cosmetic pencil.
